(19) United States
(12) Patent Application Publication
(10) Pub. No.: US 2014/0212645 A1
(43) Pub. Date: Jul. 31, 2014

(54) OPTICAL COMPOSITE SHEET

(71) Applicants: Ikuo Mimura, Uozu-shi (JP); Atsushi Shibata, Uozu-shi (JP); Naoki Musashi, Uozu-shi (JP); Shinya Hattori, Uozu-shi (JP); Ippei Imagawa, Uozu-shi (JP)

(72) Inventors: Ikuo Mimura, Uozu-shi (JP); Atsushi Shibata, Uozu-shi (JP); Naoki Musashi, Uozu-shi (JP); Shinya Hattori, Uozu-shi (JP); Ippei Imagawa, Uozu-shi (JP)

(73) Assignee: NIPPON CARBIDE INDUSTRIES CO., INC., Minato-ku, Tokyo (JP)

(21) Appl. No.: 14/240,427

(22) PCT Filed: Aug. 23, 2012
(86) PCT No.: PCT/JP2012/071299

§ 371 Date: Feb. 24, 2014

(30) Foreign Application Priority Data
Aug. 26, 2011 (JP) 2011-185351

(51) Int. Cl. F21V 8/00; G02B 1/04

(52) U.S. Cl. CPC G02B 6/0065; G02B 1/045
USPC 428/212

(57) ABSTRACT

The optical composite sheet 1 includes a first optical layer 10 and a second optical layer 20, and a low-refractive index layer 30 that is laminated at least between the first optical layer 10 and the second optical layer 20 and has a lower refractive index than the refractive indices of the first optical layer 10 and the second optical layer 20. The low-refractive index layer 30 is characterized by containing many particles 50 having an average particle size of 5 nm to 300 nm, a binder resin 35 that binds the surface sites of the particles 50 to each other, and gaps 36 that are formed among the particles.

### TECHNICAL FIELD

The present invention relates to an optical composite sheet that can suitably lower the refractive index of a low-refractive index layer and improve the resistance against outer force.

### BACKGROUND ART

Liquid crystal displays are used in small-sized electronic instruments such as mobile phones and PDAs (Personal Digital Assistants), and in stationary television sets, and the like. A backlight system is generally adopted to liquid crystal displays used in such small-sized electronic instruments, television sets and the like, and light is irradiated from the back surface of a liquid crystal display. The backlight mainly includes an edge-light type (also referred to as a side-light type) and a direct type.

An edge-light type backlight includes a light guide sheet and a light source as main constitutions. The light guide sheet is configured to allow transmission of light, and one main surface thereof opposing to a liquid crystal unit is an outgoing plane and one lateral side that is approximately perpendicular to this outgoing plane is an incident plane. The light source is disposed so as to face the incident plane. Furthermore, the light that exits from the light source enters into the light guide sheet from the incident plane of the light guide sheet and travels while being reflected in the light guide sheet, and light having a relatively high NA (Numerical Aperture) against the outgoing plane exits from the outgoing plane.

For example, the following Patent Document 1 describes such light guide sheet (light guide plate). The light guide sheet described in the following Patent Document 1 has a constitution including an outgoing plane that is planar and has undergone a nonreflecting treatment, prisms formed on the plane on the opposite side of the side of the outgoing plane, and a sheet on the outgoing plane side and a sheet on the opposite side of the side of the outgoing plane that are attached to each other by an adhesive. The respective sheets and adhesive are each transparent, and the sheet on the light outgoing plane side has a refractive index of 1.490, the sheet on the opposite side of the side of the outgoing plane has a refractive index of 1.585, and the adhesive has a refractive index of 1.481. It is considered that, when light enters into such light guide sheet from the lateral side, the light travels along the plane direction, a part of the traveling light is reflected on the prism plane, and the light that has been reflected on the prism plane exits from the outgoing plane.

### CITATION LIST

### Patent Document

[Patent Document 1] Japanese Patent Application Laid-Open No. 2003-4950

### SUMMARY OF INVENTION

### Objects to be Achieved by the Invention

However, in the light guide sheet described in Patent Document 1, the refractive index of the adhesive as a low-refractive index layer is not so low, and the light is difficult to be reflected on the interface of the low-refractive index layer, and thus a part of the light that has traveled to the plane on the opposite side of the outgoing plane tends to easily emit from the plane opposite to the side of the outgoing plane on the plane opposite to the outgoing plane. Therefore, such light guide sheet has a problem that light does not suitably travel in the light guide sheet, and thus the luminance at a place that is distant from the light incident plane is lowered.

The present inventors considered that the refractive index of the adhesive can be lowered if fluorine is incorporated into the resin that constitutes the adhesive in the light guide sheet described in Patent Document 1. However, since it is known that the adherability of a resin is lowered when fluorine is incorporated into the resin, when a fluorine-containing resin is adopted as an adhesive, the resistance against outer force such as bending is significantly deteriorated.

The present invention aims at providing an optical composite sheet that can suitably lower the refractive index of a low-refractive index layer and improve the resistance against outer force.

### Means for Achieving the Objects

The optical composite sheet of the present invention is characterized by inducing a first optical layer and a second optical layer, and a low-refractive index layer that is laminated between at least the first optical layer and the second optical layer and has a lower refractive index than the refractive indices of the first optical layer and the second optical layer, wherein the low-refractive index layer contains many particles having an average particle size of 5 nm to 300 nm, a binder resin that binds the surface sites of the particles to each other, and gaps that are formed among the particles.

According to such optical composite sheet, since the low-refractive index layer contains gaps among the many particles, the refractive index can be lowered as a whole. The particles can retain their own strength in the case when the particle size is 5 nm or more, and can sufficiently transmit light and can be dispersed in an organic solvent in the case when the particle size is 300 nm or less, and thus the particles can improve the strength and light transparency in the low-refractive index layer by having an average particle size included in the low-refractive index layer of 5 nm to 300 nm. Furthermore, since the surface sites of the particles are bonded to each other by the binder resin, while gaps are formed among the particles, generation of cracks and the like in the low-refractive index layer through the gaps is suppressed by the binder resin. Therefore, the resistance against outer force is significantly improved as compared to the case when the binder resin is omitted. When light enters into the first optical layer along the plane direction of such optical composite sheet, the light travels mainly in the optical composite sheet. Therefore, the light that travels in the first optical layer can be reflected on the boundary of the first optical layer and low-refractive index layer to thereby lower the incidence of the light into the low-refractive index layer. Therefore, according to such optical composite sheet, light can be suitably transmitted. Furthermore, when light enters perpendicularly to the plane direction of the composite sheet, this light can be suitably inflected in the low-refractive index layer.

Furthermore, the particles are preferably hollow particles. In the low-refractive index layer containing such hollow particles, gaps are formed among the particles and spaces are present in the particles themselves, and thus the refractive index of the entirety of the low-refractive index layer can further be lowered.

Furthermore, the range of the particle size distribution of the particles is preferably in the range of 90 to 110% of the average particle size. In such range, the strength of the low-refractive index layer can further be improved.

Furthermore, it is preferable that the optical composite sheet includes intermediate layer(s) at least one of between the first optical layer and the low-refractive index layer and between the second optical layer and the low-refractive index layer, and the intermediate layer(s) is/are softer than the first optical layer and the second optical layer.

According to the optical composite sheet including such intermediate layer(s), the intermediate layer(s) suppress(es) the transmission of force applied from outside to the low-refractive index layer. Therefore, generation of cracks and the like in the low-refractive index layer can be suppressed, and thus the resistance against outer force is further improved.

Furthermore, it is preferable that the intermediate layer(s) is/are softer than the binder resin.

If such relation between the intermediate layer(s) and the binder resin is possessed, then the intermediate layer(s) can relax outer force, and the binder resin can support the low-refractive index layer against outer force so as to prevent the crush of the low-refractive index layer, and thus the resistance against outer force can further be improved. Meanwhile, if such relation is possessed, then it becomes possible to prevent the low-refractive index layer from being crushed by a pressure applied in a press step in the case when the press step is used in the process of the production of the optical composite sheet. Therefore, it is also advantageous in the production steps to have such relationship.

Furthermore, it is preferable that the average particle size of the particles is 30 nm to 100 nm. According to such average particle size of the particles, the strength of the particles themselves can further be retained, and the particles can sufficiently transmit light and can be dispersed in an organic solvent.

Furthermore, it is preferable that the low-refractive index layer has a refractive index of 1.21 to 1.37. It is preferable that the specific refractive index between the first optical layer and the second optical layer, and the low-refractive index layer is 0.71 to 0.92.

Such low-refractive index layer allows fine reflection of light on the boundary thereof.

Furthermore, in the case when the volume of the particles is regarded as (A), the volume of the gaps is regarded as (B), and the volume of the binder resin is regarded as (C), the ratio (A):(B):(C) is preferably 50 to 75:10 to 49:1 to 40.

The low-refractive index layer having such ratio is preferable since the low-refractive index layer can ensure resistance against outer force and can lower the refractive index of the low-refractive index layer.

Furthermore, it is preferable that prisms or lens are formed on the top surface and/or rear surface of the optical composite sheet of the present invention.

According to such optical composite sheet, in the case when light travels along the plane direction of the optical composite sheet, at least a part of light to be fully-reflected on the top surface of the first optical layer in the case when the top surface of the first optical layer is a plane can exit from the first optical layer by the formation of the prisms on the first optical layer. Furthermore, the amount of the light that exits from the first optical layer can be controlled by controlling the design or the prisms. Therefore, a light diffusion sheet having a suitably-controlled amount of outgoing light can be formed by using such optical composite sheet as a light diffusion sheet. Furthermore, in the case when light enters perpendicularly to the plane direction of the optical composite sheet, the inflection direction of the incident light can be controlled by controlling the design of the prisms.

### Effect of Invention

As mentioned above, according to the present invention, an optical composite sheet that can suitably lower the refractive index of a low-refractive index layer is provided.

### BRIEF DESCRIPTION OF DRAWINGS

FIG. 1 is a drawing show rig the appearance of the structure on the cross-sectional surface of the optical composite sheet according to the first embodiment of the present invention.

FIG. 2 is drawing showing the side of the first optical layer of the low-refractive index layer of FIG. 1 with enlargement.

FIG. 3 is a drawing showing the side of the second optical layer of the low-refractive index layer of FIG. 1 with enlargement.

FIG. 4 is a drawing showing the particles in the low-refractive index layer.

FIG. 5 is a drawing showing the appearance of the structure on the cross-sectional surface of the optical composite sheet according to the second embodiment of the present invention.

FIG. 6 is a drawing showing the appearance of the structure on the cross-sectional surface of the optical composite sheet according to the third embodiment of the present invention.

FIG. 7 is a drawing showing the appearance of the structure on the cross-sectional surface of the optical composite sheet according to the fourth embodiment of the present invention.

### DESCRIPTION OF EMBODIMENTS

The preferable embodiments of the optical composite sheet according to the present invention will be explained below in detail referring to the drawings.

### First Embodiment

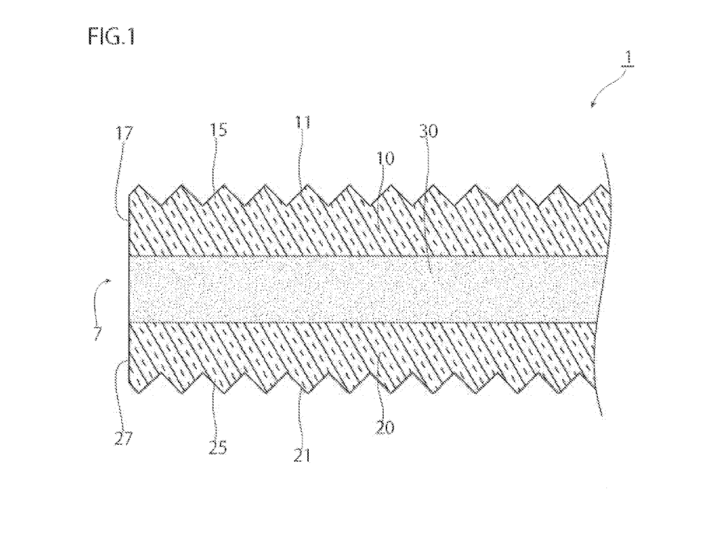

FIG. 1 is a drawing showing the appearance of the structure on the cross-sectional surface of the optical composite sheet according to the first embodiment of the present invention.

As shown in FIG. 1, the optical composite sheet 1 of the present embodiment includes a first optical layer 10 and a second optical layer 20, and a low-refractive index layer 30 that is laminated between the first optical layer 10 and second optical layer 20, as main constitutions. Furthermore, in the optical composite sheet 1 of the present embodiment, a plane 11 that is opposite to the side of the low-refractive index layer 30 of the first optical layer 10 is a light outgoing plane, and one lateral side 7 of the optical composite sheet 1 is a light incident plane. Specifically, the optical composite sheet 1 of the present embodiment has a function as a light diffusion sheet that transmits light emitted from the incident plane along the plane direction, and further exits at least a part of the light that has traveled along the plane direction from the outgoing plane.

The first optical layer 10 is disposed so as to cover the entirety of the plane direction of the optical composite sheet 1, and one lateral side 17 of the first optical layer 10 is deemed to be a part of the incident plane. Furthermore, in the first optical layer 10, many prisms 15 are formed on the side of the one plane 11 that is deemed to be a light outgoing plane to thereby make the outgoing plane a textured prism plane. Although the shape of the prisms 15 is not specifically limited, it is preferable that grooves are formed by the respective prisms 15 at least in parallel to the longitudinal direction of the one lateral side 17. As mentioned above, the one lateral side 17 is a part of the incident plane, and thus the light that has entered from the incident plane tends to travel perpendicularly to the longitudinal direction of the one lateral side 17. Therefore, the direction of the grooves formed by the respective prisms 15 and the transmission direction of the light becomes approximately perpendicular by forming the grooves in such way, and thus the light that has entered from the incident plane is allowed to easily emit from the outgoing plane.

Furthermore, the first optical layer 10 is constituted by a light transmissive material, and it is preferable that the material is preferably a material having a total light transmittance of 30% or more, more preferably a material having a total light transmittance of 50% or more, and further preferably a material having a total light transmittance of 70% or more. Since the total light transmittance is high as mentioned above, light cart be emitted while further suppressing the loss of the incident light. Although such material is not specifically limited as long as it is a light transmissive material, the material may include inorganic substances such as silica, and resins such as (meth)acrylic resins, polycarbonate resins, polyester resins, polystyrene resins, polyvinyl chloride resins, fluorine resins, polyolefin resins, cellulose acetate resins, silicone-based resins, polyamide resins, epoxy-based resins, polyacrylonitrile resins and polyurethane resins. The total light transmittance is measured based on JIS K7105 by using a light source A. The light source A is one of the specifications for standard light sources defined by CIE (Commission Internationale de l'Eclairage), and is light emitted from a tungsten light bulb and has a color temperature of 2856 Kelvin.

Furthermore, although the refractive index of the first optical layer 10 is not specifically limited, it is set to, for example, 1.5 to 1.7. The refractive index can be measured by using an ellipsometer at a wavelength of 589 nm.

The second optical layer 20 is disposed so as to cover the entirety of the plane direction on the opposite side of the first optical layer 10 in the optical composite sheet 1, and one lateral side 27 of the second optical layer 20 is deemed to be a part of the incident plane. Furthermore, a plane 21 on the opposite side of the side of the low-refractive index layer 30 of the second optical layer 20 is deemed to be a light reflective plane. Many prisms 25 are formed on the side of the light reflective plane of the second optical layer 20, and thus the light reflective plane is formed into a textured prism plane. Although the shape of the prisms 25 is not specifically limited, it is preferable that grooves are formed by the respective prisms 25 at least in parallel to the longitudinal direction of the lateral side 17. Furthermore, the prisms 25 may have a shape that is in a plane-symmetrical relationship to the prisms 15 on the side of the opposite plane of the optical composite sheet 1 or a different shape.

The prisms 25 each has a shape that allows diffusion, inflection and total reflection of light, and a V-shaped linear prism, a U-shaped linear prism, a trigonal pyramid prism and a tetragonal pyramid prism can be exemplified.

Furthermore, the second optical layer 20 is constituted by a light transmissive material in a similar manner to that for the first optical layer 10, and it is preferable that the material is preferably a material having a total light transmittance of 30% or more, more preferably a material having a total light transmittance of 50% or more, and further preferably a material having a total light transmittance of 70% or more. Since the total light transmittance is high as mentioned above, light can be emitted while further suppressing the loss of the incident light. As the material for such second optical layer 20, similar materials to those for the first optical layer 10 can be exemplified.

Furthermore, although the refractive index of the second optical layer 20 is not specifically limited, it is set to be, for example, similar to the refractive index of first optical layer 10.

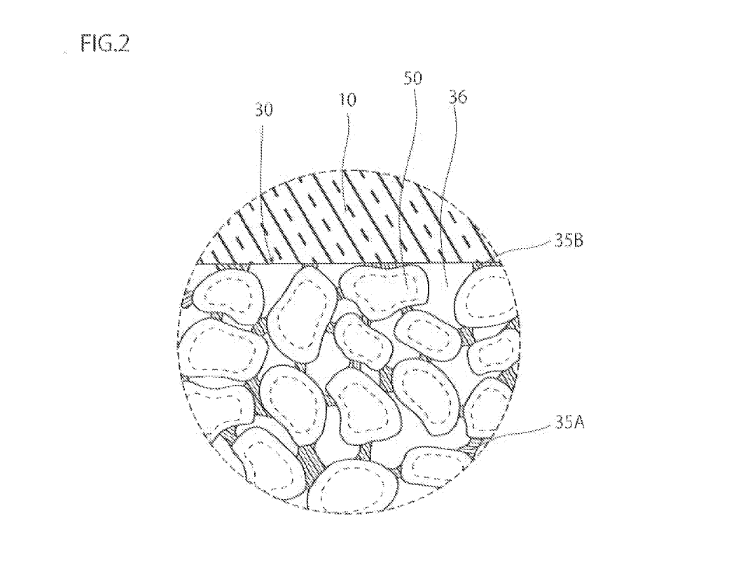

FIG. 2 is drawing showing the side of the first optical layer of the low-refractive index layer of FIG. 1 with enlargement. FIG. 3 is a drawing showing the side of the second optical layer of the low-refractive index layer of FIG. 1 with enlargement. As shown in FIGS. 2 and 3, the low-refractive index layer 30 is constituted by many particles 50 and a binder resin 35.

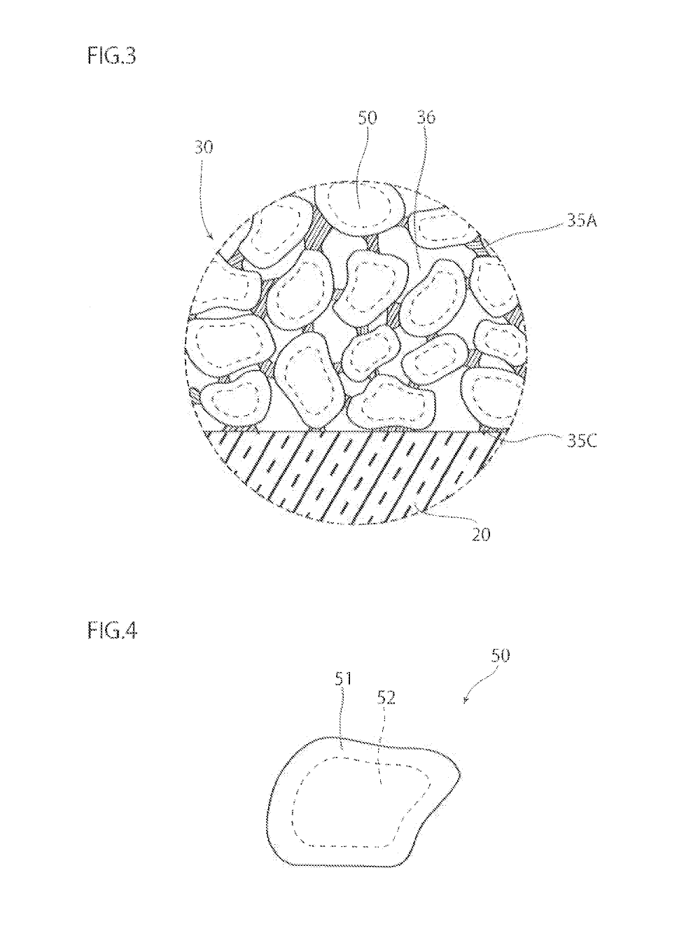

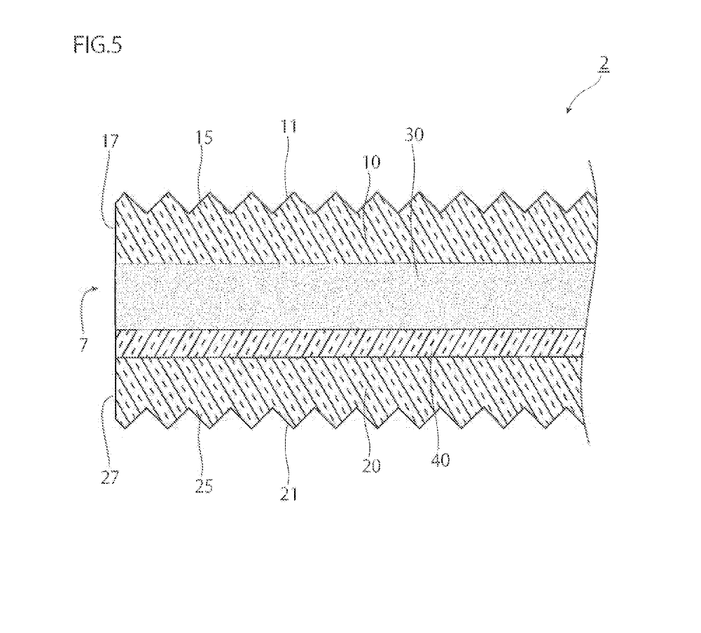

FIG. 4 is an enlarged drawing of the particle 50. As shown in FIG. 4, the particle 50 is formed of a solid or hollow shell 51 having light transparency, and in the case when the particle 50 is a hollow particle, a space 52 surrounded by a shell 51 is formed.

As the material for the shell 51, similar materials to those for the first optical layer 10 can be exemplified. Examples of such particles 50 may include trade names: EPOSTAR, SEAHOSTAR and SOLIOSTAR, manufactured by Nippon Shokubai. Co., Ltd.; trade name: OPTBEADS, manufactured by Nissan Chemical Industries, Ltd.; trade name: ARTPEARL, manufactured by Negami Chemical Industrial Co., Ltd.; trade name: DAIMIC BEADS, manufactured by Dainichiseika Color & Chemicals Mfg. Co., Ltd.; trade name: GANZPEARL, manufactured by Ganz Chemical. Co., Ltd.; trade name: TECHPOLYMER, manufactured by Sekisui Plastics Co., Ltd.; and trade name: CHEMISNOW, manufactured by Soken Chemical Engineering Co., Ltd. Furthermore, in the case when the particles 50 are hollow particles, the material for the shell 51 is preferably silica. Such hollow particles may include SILINAX (registered trademark) manufactured by Nittetsu Mining Co., Ltd. and SLURIA (registered trademark) manufactured by JGC C&C). Although the shape of the particles 50 is not specifically limited as long as they show a low refractive index, the shape may be a spherical shape or an amorphous shape.

Furthermore, the average particle size of the particles 50 is preferably lower than the wavelength of the light that enters into the optical composite sheet 1, i.e., the light that travels in the first optical layer 10. Since the average particle size of the particles 50 is preferably lower than the wavelength of the light that travels in the first optical layer 10, the irregular reflection of the light in the low-refractive index layer 30 can be suppressed, and thus unintended exit of the light from the outgoing plane can be suppressed. Furthermore, the average particle size of the particles 50 is more preferably lower than the half, further preferably lower than the quarter, of the wavelength of the light that enters into the optical composite sheet 1. For example, in the case when light at 420 nm to 800 nm enters into the optical composite sheet 1, the average particle size of the particles 50 may be more preferably 30 to 100 nm. In addition, in the case when the range of the particle size distribution of the particles is in the range of 90 to 110% of the average particle size, the particle sizes of the particles become approximately even, and thus the range is preferable from the viewpoint of improvement of the strength of the low-refractive index layer 30.

In order to measure the average particle size and the range of particle size distribution of the particles 50, it is only necessary to measure by a dynamic light scattering method.

Furthermore, in the case when the particles 50 are hollow particles, it is preferable that the ratio of average space 52 of the particles 50 is higher from the viewpoint of lowering of the refractive index of the low-refractive index layer 30, and is preferably 10% to 60% from the viewpoint of ensuring the strength of the particles 50.

On the other hand, as shown in FIGS. 2 and 3, the binder resin 35 is formed of a binder resin 35A that binds the surface sites of the particles 50 to each other, a binder resin 35B that binds the surface sites of the first optical layer 10 and particles 50 to each other, and a binder resin 35C that binds the surface sites of the second optical layer 20 and the particles 50 to each other.

By these binder resins 35A to 35C, gaps 36 are formed among the particles 50. From the viewpoint of increasing the volumes of the gaps 36, it preferable that the surface sites of the particles 5C, the surface sites of the first optical layer 10 and the particles 50, and the surface sites of the second optical layer 20 and the particles 50 are respectively in positional relationships that they are closely disposed to each other. Furthermore, it is preferable that the particles 50 are in a non-contact state with each other, the first optical layer 10 and each of the plural particles 50 are in a non-contact state with each other, and the second optical layer 20 and each of the plural particles 50 are in a non-contact state with each other.

The material for such binder resins 35A to 35C has light transparency, and examples may include an acrylic resin, an urethane resin, an epoxy resin, a vinyl ether resin, a styrene resin, a silicon resin and a silane coupling agent, and an acrylic resin, a vinyl ether resin and a silane coupling agent are preferable since they have low refractive indices. Furthermore, in view of lowering the refractive index, it is preferable that the material for the binder resins 35A to 35C contains fluorine. For example, a fluorinated acrylic resin and a fluorinated vinyl ether resin can be exemplified.

The silane coupling agent used for the binder resin 35 is not specifically limited. Examples may include vinyl group-containing silane coupling agents such as vinyltrimethoxysilane and vinyltriethoxysilane, epoxy group-containing silane coupling agents such as glycidoxypropyltrimethoxysilane, (meta)acryl group-containing silane coupling agents such as methacryloyloxypropyltrimethoxysilane and acryloyloxypropyltrimethoxysilane, isocyanate group-containing silane coupling agents such as isocyanatepropyltrimethoxysilane, mercapto group-containing silane coupling agents such as mercaptopropyltrimethoxysilane, amino group-containing silane coupling agents such as aminopropyltriethoxysilane, and the like. As such silane coupling agents, product names: KBE series and KBM series manufactured by Shin-Etsu Silicone Co., Ltd. can be exemplified.

Furthermore, when the volume of the particles 50 is regarded as (A), the volume of the gaps 36 formed among the particles 50 is regarded as (B), and the volume of the binder resin 35 is regarded as (C), the ratio (A):(B):(C) is preferably 50 to 75:10 to 49:1 to 40, from the viewpoints that the low-refractive index layer can ensure resistance against cuter force, and that the refractive index of the low-refractive index layer 30 can be lowered.

The total volume of the binder resins 35A to 35C in the particles 50 is preferably lower, from the viewpoint of increasing the volume of each gap 36 among the particles 50. The ratio (A):(B):(C) is preferably 55 to 75:15 to 44:1 to 30, especially preferably 60 to 75:20 to 39:1 to 20, from the viewpoints that the low-refractive index layer 30 ensures resistance against outer force, and that the refractive index of the low-refractive index layer 30 is lowered.

Such low-refractive index layer 30 composed of the many particles 50 and the binder resin 35 has a lower refractive index than the refractive indices of the first optical layer 10 and the second optical layer 20. For example, the refractive index of the low-refractive index layer 30 is set to 1.21 to 1.37, and the specific refractive index with the first optical layer 10 and second optical layer 20 is set to 0.71 to 0.92. Since the specific refractive index between the first optical layer 10 and the second optical layer 20, and the low-refractive index layer 30 is such specific refractive index, light can be suitably reflected on the boundary of the first optical layer 10 and the low-refractive index layer 30. For example, when the first optical layer 10 and the second optical layer 20 are respectively formed of a polycarbonate having a refractive index of 1.58 and the low-refractive index layer 30 has a refractive index of 1.21 to 1.37, the specific refractive index between the first optical layer 10 and the second optical layer 20, and the low-refractive index layer 30 is 0.766 to 0.867.

As mentioned above, the optical composite sheet 1 including such first optical layer 10, second optical layer 20 and low-refractive index layer 30 has a function as a light diffusion sheet. Specifically, a light source formed of an LED and the like, which is not depicted, is disposed so as to face the incident plane. The light emitted from the light source enters from the incident plane. Of which, the light that enters into the first optical layer 10 travels in mainly the first optical layer 10. Specifically, the light travels in the first optical layer 10 while being reflected between the boundary of the first optical layer 10 and the low-refractive index layer 30 and the outgoing plane, and light having a high NA with respect to the outgoing plane exits from the outgoing plane.

Furthermore, the light having a high NA with respect to the boundary of the first optical layer 10 and the low-refractive index layer 30 enters into the low-refractive index layer. 30 from the first optical layer 10, and further enters into the second optical layer 20 from the low-refractive index layer 30. At least a part of the light that has entered into the second optical layer 20 is reflected on the reflective plane. Specifically, light having a low NA with respect to the reflective plane of the second optical layer 20 is reflected on the reflective plane, and enters again into the first optical layer 10 from the low-refractive index layer 30. On the other hand, the light having a high NA with respect to the reflective plane transmits the reflective plane and exits from the optical composite sheet 1. The light that that has entered into the first optical layer 10 travels again in the first optical layer 10.

The optical composite sheet 1 as mentioned above can be produced as follows.

Firstly, a preparation solution of the particles 50 and the binder resin 35 is obtained. Specifically, the preparation solution is, for example, 2-hydroxyethyl acrylate, acrylic acid, a silane coupling agent and a UV polymerization initiator. The preparation solution is prepared by, in the case when the particles 50 are deemed to be 100% by weight, by setting the 2-hydroxyethyl acrylate to 1.5% by weight, the acrylic acid to 0.5% by weight, the silane coupling agent to 0.5% by weight, and the UV polymerization initiator to 0.025% by weight, and the like. Furthermore, the first optical layer 10 and the second optical layer 20 are respectively prepared.

Next, for example, using a spin coater, the preparation solution is applied onto the first optical layer 10, at a thickness of, for example, 1 μm. Furthermore, the second optical layer 20 is superposed, and ultraviolet ray is then irradiated under a condition of, for example, 250 mJ/cm2×10 seconds. By this irradiation, the binder resin 35 (35A to 35C) is formed, and thereby the low-refractive index layer 30 is obtained, and the adhesion strength between the low-refractive index layer 30, and the first optical layer 10 and the second optical layer 20 is increased. By this way, the opt cal composite sheet 1 shown in FIG. 1 is obtained.

As explained above, according to the optical composite sheet 1 of the present embodiment, since the surface sites of the particles 50 are bonded to each other by the binder resin 35A in the low-refractive index layer 30, the gaps 36 are also formed among the particles 50 by the binder resin 35A, and the refractive index of the entirety of the low-refractive index layer 30 can be decreased by the gaps 36. Furthermore, when the particles 50 are hollow particles, the low-refractive index layer 30 includes many particles 50, and thus the refractive index can be decreased as a whole by the spaces in the particles 50. In addition, since generation of cracks and the like against the low-refractive index layer through the gaps 36 is suppressed by the binder resin, while the gaps 36 are formed among the particles 50, the resistance against outer force is significantly improved as compared to the case when the binder resin is omitted.

Furthermore, in the case when the optical composite sheet 1 is used as a light diffusion sheet in which light enters from the one lateral side 7 as mentioned above and the light exits from the plane 11 on the opposite side of the side of the low-refractive index layer 30 of the first optical layer 10, when light enters into the first optical layer 10, the light travels in mainly the first optical layer 10. Furthermore, since the low-refractive index layer 30 contains the many particles 50, the refractive index can be lowered as a whole by the gaps 36 among the particles 50. Therefore, the light that travels in the first optical layer 10 is reflected on the boundary of the first optical layer 10 and the low-refractive index layer 30, thereby incidence of the light into the low-refractive index layer 30 can be lowered. Therefore, according to such optical composite sheet 1, light can be suitably transmitted.

Furthermore, in the case when the optical composite sheet 1 of the above-mentioned embodiment is used as a light diffusion sheet, since the prisms 15 are formed on the opposite side of the side of the low-refractive index layer 30 of the first optical layer 10, at least a part of the light that should be fully-reflected on the top surface of the first optical layer 10 in the case when the top surface of the first optical layer 10 is a planar plane can exit from the first optical layer 10. Furthermore, the amount of the light that exits from the first optical layer 10 can be controlled by controlling the design of the prisms 15. Therefore, a light diffusion sheet having a suitably-controlled amount of outgoing light can be formed by using such optical composite sheet 1 as a light diffusion sheet.

In addition, in the case when the optical composite sheet 1 of the above-mentioned embodiment is used as a light diffusion sheet, the light having a high NA with respect to the low-refractive index layer 30 travels from the first optical layer 10 to the second optical layer 20 through the low-refractive index layer 30, even how the first optical layer 10 and the low-refractive index layer 30 are optimally designed. However, since the prisms 25 are formed on the opposite side of the side of the low-refractive index layer 30 of the second optical layer 20 in the above-mentioned embodiment, the amount of reflection of the light that has traveled to the second optical layer 20 on the reflective plane of the second optical layer 20 and the amount of the light that exits from the reflection plane of the second optical layer 20 can be suitably controlled by controlling the prisms 25 formed on the second optical layer 20.

Furthermore, although the case when the optical composite sheet 1 is used as a light diffusion sheet has been explained in the above-mentioned embodiment, the optical composite sheet 1 is not limited to a light diffusion sheet and the use thereof is not specifically limited. For example, the optical composite sheet 1 may be an optical sheet in which light enters from the plane 11 on the opposite side of the side of the low-refractive index layer 30 of the first optical layer 10, and the light exits from the plane 21 on the opposite side of the side of the low-refractive index layer 30 of the second optical layer 20. In this case, the direction of the incident light in the optical composite sheet 1 can be controlled by the prisms 15 and 25, and the direction of the outgoing light can further be controlled by the prisms 25. Alternatively, the optical composite sheet 1 may be a total y-reflective sheet in which light enters from the plane 11 on the opposite side of the side of the low-refractive index layer 30 of the first optical layer 10, and the light is folly reflected on the plane 21 on the opposite side of the side the low-refractive index layer 30 of the second optical layer 20, by controlling the designs of the prisms 15 and prisms 25. Furthermore, by optimizing the designs of the prisms 15 and 25, a light guide sheet that transmits light that has entered from the one lateral side 7 to the lateral side on the opposite side of the one lateral side 7 can be formed.

### Second Embodiment

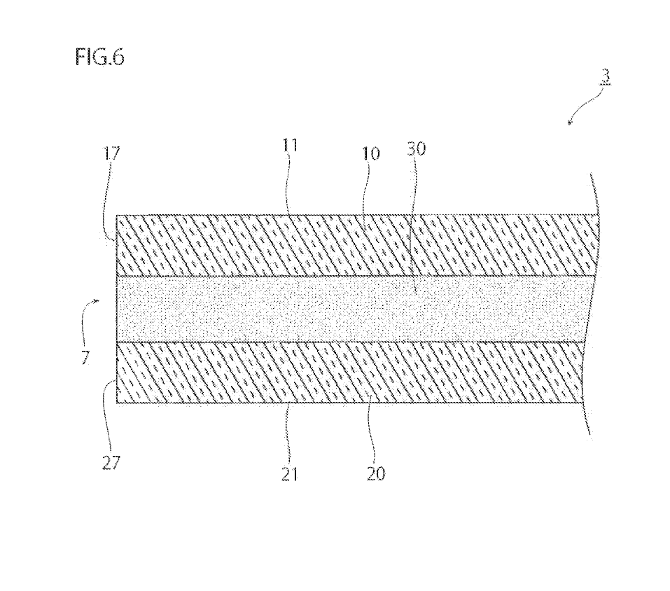

Secondly, the second embodiment of the present invention will be explained in detail referring to FIG. 5. With respect to the constitutional elements that are identical or equivalent to those of the first embodiment, the same reference symbols are provided and redundant explanations are omitted, except for the cases when the constitutional elements are specifically explained. FIG. 5 is a drawing showing the appearance of the structure on the cross-sectional surface of the optical composite sheet according to the second embodiment of the present invention.

As shown in FIG. 5, the optical composite sheet 2 of the present embodiment is different from the optical composite sheet 1 of the first embodiment in that ii includes an intermediate layer 40 between a second optical layer 20 and a low-refractive index layer 30.

The intermediate layer 40 is disposed on the entirety of the gap between the second optical layer 20 and the low-refractive index layer 30, and is formed of a soft material. Specifically, the intermediate layer 40, which is a soft material, has a storage modulus in the range of preferably 5×10̂6 Pa to 5×10̂7 Pa, more preferably 1×10̂7 Pa to 3×10̂7 Pa, and further preferably 1.65×10̂7 Pa to 1.8×10̂7 Pa. For example, the intermediate layer 40 is preferably softer than the second optical layer 20.

Since the intermediate layer 40 has a storage modulus of 5×10̂6 Pa or more, it is preferable since the refractive index can be decreased, and since the storage modulus is 5×10̂7 Pa or less, it is preferable since the adhesion strength between the second optical layer 20 and the intermediate layer 40 is easily obtained. Furthermore, it is preferable that the intermediate layer 40 is softer than the binder resin 35 from the viewpoint of improving the resistance against outer force. Furthermore, as the relationship between the intermediate layer 40 and the binder resin 35, it is preferable that the intermediate layer 40 is softer than the binder resin 35 from the viewpoint of improving the resistance against outer force. In addition, it is desirable that the intermediate layer 40 has adherability. This is because outer force can be relaxed by the stickiness, and the interlaminar delamination between the intermediate layer and the second optical layer 20 or low-refractive index layer 30 can be suppressed.

Although the material for such intermediate layer 40 is not specifically limited as long as it is a soft material, examples may include an acrylic resin, a vinyl ether resin and the like. For example, in the case when the second optical layer 20 is polycarbonate, the intermediate layer is preferably an acrylic resin.

Furthermore, it is preferable that the refractive index of the intermediate layer 40 is equal to or more than the refractive index of the low-refractive index layer 30, and the refractive index of the intermediate layer 40 is between the refractive index of the second optical layer 20 and the refractive index of the low-refractive index layer 30. By setting the refractive index of the intermediate layer 40 to between the refractive index of the second optical layer 20 and the refractive index of the low-refractive index layer 30, the refractive index is gradually increased from the second optical layer 20 to the low-refractive index layer 30. Therefore, when the light travels from the second optical layer 20 to the low-refractive index layer 30, the light easily travels from the second optical layer 20 to the intermediate layer 40, and further easily travels from the intermediate layer 40 to the low-refractive index layer 30. Therefore, the light that has traveled from the first optical layer 10 to the second optical layer 20 through the low-refractive index layer 30 can be made easy to return to the first optical layer 10.

In order to produce such optical composite sheet 2, a resin that becomes the intermediate layer 40 is applied onto a resin sheet that becomes the second optical layer 20 before laminating the first optical layer 10 and the second optical layer 20 through the low-refractive index layer 30 in the production of the optical composite sheet 1 in the first embodiment. Furthermore, it is only necessary to laminate the first optical layer 10 and the second optical layer 20 so that the intermediate layer 40 is disposed on the side of the low-refractive index layer 30 and integrate the respective resin sheets in a similar manner to that of the first embodiment.

According to the optical composite sheet 2 of the present embodiment, the refractive index of the low-refractive index layer 30 can be suitably lowered, and furthermore, by having a soft intermediate layer 40, when stress is applied from outside, the intermediate layer 40 prevent the stress from traveling to the low-refractive index layer 30. Therefore, formation of cracks and the like in the low-refractive index layer 30 can be suppressed.

Although the intermediate layer 40 is disposed between the second optical layer and the low-refractive index layer 30 in the above-mentioned second embodiment, the present invention is not limited to this, and the intermediate layer 40 may be disposed only between the first optical layer 10 and the low-refractive index layer 30. In this case, the intermediate layer is preferably softer than the first optical layer 10. Furthermore, an intermediate layer can further be disposed between the first optical layer 10 and the second optical layer 20, and the low-refractive index layer 30, so as to sandwich the low-refractive index layer 30. In this case, the intermediate layer is preferably softer than the first optical layer 10 and the second optical layer 20. Furthermore, it is preferable that the intermediate layer 40 is softer than the binder resin 35 from the viewpoint of improving the resistance against outer force.

As in the first embodiment, the optical composite sheet 2 of the present embodiment can be a light diffusion sheet in which light enters from one lateral side 7 and the light exits from a plane 11 that is on the opposite side of the low-refractive index layer of the first optical layer 10. Furthermore, by optimizing the designs of the prisms 15 and 25, a light guide sheet that transmits light that has entered from the one lateral side 7 to the lateral side on the opposite side of the one lateral side 7 can be formed. Furthermore, as in the first embodiment, the optical composite sheet 1 may be an optical sheet in which light enters from the plane 11 on the opposite side of the side of the low-refractive index layer 30 of the first optical layer 10, and the light exits from a plane 21 on the opposite side of the side of the low-refractive index layer 30 of the second optical layer 20. In this case, the direction of the incident light in the optical composite sheet. 1 can be controlled by the prisms 15 and 25, and the direction of the outgoing light can further be controlled by the prisms 25. Alternatively, the optical composite sheet 1 may be a totally-reflective sheet in which light enters from the plane 11 on the opposite side of the side of the low-refractive index layer 30 of the first optical layer 10, and the light is fully reflected on the plane 21 on the opposite side of the side of the low-refractive index layer 30 of the second optical layer 20, by controlling the designs of the prisms 15 and prisms 25.

### Third Embodiment

Next, the third embodiment of the present invention will be explained in detail referring to FIG. 6. With respect to the constitutional elements that are identical or equivalent to those of the first embodiment, the same reference symbols are provided and redundant explanations are omitted, except for the cases when the constitutional elements are specifically explained. FIG. 6 is a drawing showing the appearance of the structure on the cross-sectional surface of the optical composite sheet according to the third embodiment of the present invention.

As shown in FIG. 6, the optical composite sheet 3 is different from the optical composite sheet 1 of the first embodiment in that the plane 11 on the opposite side of the low-refractive index layer 30 of the first optical layer 10 is formed into a planer shape and the plane 21 on the opposite side of the low-refractive index layer 30 of the second optical layer 20 is formed into a planer shape.

According to such optical composite sheet 3, the refractive index of the low-refractive index layer 30 can be suitably lowered as in the optical composite sheet 1 of the first embodiment. Furthermore, the optical composite sheet 3 can be a light guide sheet that transmits light that has entered from the one lateral side 7 to the lateral side on the opposite side of the one lateral side 7, by entering of the light from the one lateral side 7. In this case, the refractive index of the low-refractive index layer 30 can be suitably lowered, and thus the light can be suitably reflected on the boundary of the first optical layer 10 and the low-refractive index layer 30, and thus the light can be suitably transmitted. For example, the optical composite sheet 3 may be an optical sheet in which light enters from the plane 11 on the opposite side of the side of the low-refractive index layer 30 of the first optical layer 10, and the light exits from the plane 21 on the opposite side of the side of the low-refractive index layer 30 of the second optical layer 20.

### Fourth Embodiment

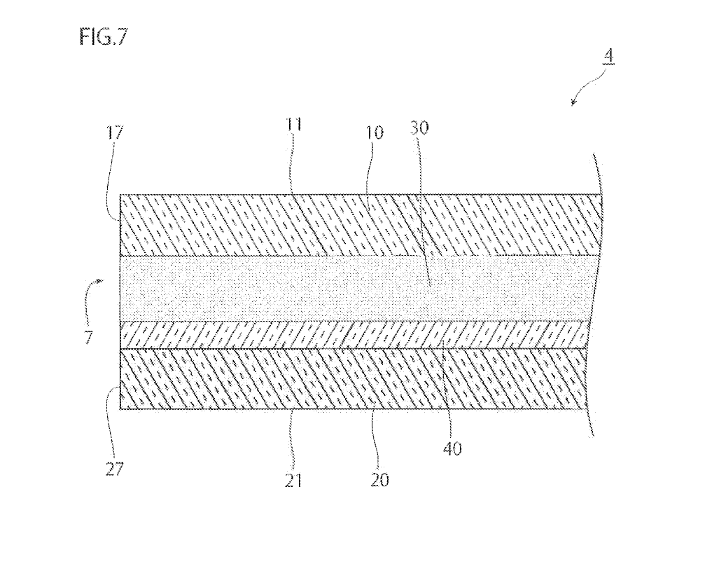

Next, the fourth embodiment of the present invention will be explained in detail referring to FIG. 7. With respect to; the constitutional elements that are identical or equivalent to those of the second embodiment, the same reference symbols are provided and redundant explanations are omitted, except for the cases when the constitutional elements are specifically explained. FIG. 7 is a drawing showing the appearance of the structure on the cross-sectional surface of the optical composite sheet according to the fourth embodiment of the present invention.

As shown in FIG. 7, the optical composite sheet 4 is different from the optical composite sheet 1 of the second embodiment in that the plane 11 on the opposite side of the low-refractive index layer 30 of the first optical layer 10 is formed into a planer shape and the plane 21 on the opposite side of the low-refractive index layer 30 of the second optical layer 20 is formed into a planer shape.

According to such optical composite sheet 4, the refractive index of the low-refractive index layer 30 can be suitably lowered as in the optical composite sheet 2 of the second embodiment, and application of stress to the low-refractive index layer 30 can be suppressed by the intermediate layer 40 in a similar manner to that of the second embodiment. Furthermore, the optical composite sheet 4 can be used as a light guide sheet that transmits light that has entered from the one lateral side 7 to the lateral side on the opposite side of the one lateral side 7, by the entering of the light from the one lateral side 7. In this case, the refractive index of the low-refractive index layer 30 can be suitably lowered, and thus the light can be suitably reflected on the boundary of the first optical layer 10 and the low-refractive index layer 30, and the light can be suitably transmitted. Furthermore, the optical composite sheet 4 may be an optical sheet in which light enters from the plane 11 on the opposite side of the side of the low-refractive index layer 30 of the first optical layer 10, and the light exits from the plane 21 on the opposite side of the side of the low-refractive index layer 30 of the second optical layer 20.

The present invention has been explained above by exemplifying the first to fourth embodiments, but the present invention is not limited to these. Furthermore, the optical composite sheets 1 to 4 in the above-mentioned embodiments may also be produced by production methods other than those mentioned above.

Furthermore, in the first and second embodiments, the explanations have been made by using the examples wherein the many prisms 15 and 25 are formed on the planes of the first optical layer 10 and second optical layer 20 as the optical composite sheets 1 and 2. However, the optical composite sheets of the present invention are not limited to these and may be optical composite sheets on which many lenses such as microlenses and lenticular lenses are formed.

### INDUSTRIAL APPLICABILITY

As explained above, according to the present invention, an optical composite sheet that can suitably lower the refractive index of a low-refractive index layer is provided.

### REFERENCE SIGNS LIST

1, 2, 3, 4: Optical composite sheet
10: First optical layer
15: Prism
20: Second optical layer
25: Prism
30: Low-refractive index layer
35: Binder resin
36: Gap
40: Intermediate layer
50: Particle
51: Shell
52: Space

1. An optical composite sheet, comprising:
a first optical layer and a second optical layer, and
a low-refractive index layer that is laminated between at least the first optical layer and the second optical layer and has a lower refractive index than the refractive indices of the first optical layer and the second optical layer,
wherein the low-refractive index layer contains many particles having an average particle size of 5 nm to 300 nm, a binder resin that binds the surface sites of the particles to each other, and gaps that are formed among the particles.

2. The optical composite sheet according to claim 1,
wherein the particles are hollow particles.

3. The optical composite sheet according to claim 1, wherein the range of the particle size distribution of the particles is in the range of 90 to 110% of the average particle size.

4. The optical composite sheet according claim 1, which comprises intermediate layer(s) at least one of between the first optical layer and the low-refractive index layer and between the second optical layer and the low-refractive index layer,
wherein the intermediate layer(s) is/are softer than the first optical layer and the second optical layer.

5. The optical composite sheet according to claim 4, wherein the intermediate layer(s) is/are softer than the binder resin.

6. The optical composite sheet according claim 1, wherein the particles have an average particle size of 30 nm to 100 nm.

7. The optical composite sheet according to claim 1, wherein the low-refractive index layer has a refractive index of 1.21 to 1.37.

8. The optical composite sheet according to claim 1, wherein the specific refractive index between the first optical layer and the second optical layer, and the low-refractive index layer is 0.71 to 0.92.

9. The optical composite sheet according to claim 1, wherein when the volume of the particles is regarded as (A), the volume of the gaps is regarded as (B), and the volume of the binder resin is regarded as (C), the ratio (A):(B):(C) is 50 to 75:10 to 49:1 to 40.

10. The optical composite sheet according to claim 1, wherein the binder resin is any of an acrylic resin, an urethane resin, an epoxy resin, a vinyl ether resin, a styrene resin, a silicon resin and a silane coupling agent.

11. The optical composite sheet according to claim 1, wherein prisms or lens are formed on the top surface and/or rear surface of the optical composite sheet.

12. The optical composite sheet according to claim 2, wherein the range of the particle size distribution of the particles is in the range of 90 to 110% of the average particle size.

13. The optical composite sheet according claim 2, wherein the particles have an average particle size of 30 nm to 100 nm.

14. The optical composite sheet according claim 3, wherein the particles have an average particle size of 30 nm to 100 nm.

15. The optical composite sheet according to claim 2, wherein the low-refractive index layer has a refractive index of 1.21 to 1.37.

16. The optical composite sheet according to claim 3, wherein the low-refractive index layer has a refractive index of 1.21 to 1.37.

17. The optical composite sheet according to claim 6, wherein the low-refractive index layer has a refractive index of 1.21 to 1.37.

18. The optical composite sheet according to claim 12, wherein the low-refractive index layer has a refractive index of 1.21 to 1.37.

19. The optical composite sheet according to claim 12, wherein the low-refractive index layer has a refractive index of 1.21 to 1.37.

20. The optical composite sheet according to claim 14, wherein the low-refractive index layer has a refractive index of 1.21 to 1.37.
